(19) United States
(12) Patent Application Publication
(10) Pub. No.: US 2017/0060194 A1
(43) Pub. Date: Mar. 2, 2017

(54) All-In-One-Laptop

(71) Applicants: Crendal Blackwell, Clinton, MD (US); Corey Sheldon, Vienna, VA (US)

(72) Inventors: Crendal Blackwell, Clinton, MD (US); Corey Sheldon, Vienna, VA (US)

(21) Appl. No.: 14/835,548

(22) Filed: Aug. 25, 2015

(51) Int. Cl. G06F 1/16

(52) U.S. Cl. CPC G06F 1/1696; G06F 1/1635; G06F 1/1643; G06F 1/1658

(57) ABSTRACT

A multi-functional All-In-One Laptop comprising multiple components integrated into one physical laptop. In a preferred embodiment, the invention comprises a laptop computer wherein power methods are comprise of AC\DC power, QI charging, USB charging, lightning cable charging and Solar power. Connectivity methods of the laptop computer invention is comprised of Ethernet, LAN, Wi-Fi, Live 5, SATCOM, and Serial connectivity ports. Additionally, the laptop computer invention is further comprised of a touchscreen and stylus component for signing contracts and a printer and scanner with paper tray and ink cartridges for scanning and printing business documents.

### BACKGROUND OF THE INVENTION

Laptop computers typically serves as tools to provide portability. A laptop computer typically consist of a motherboard, keyboard, monitor, RAM memory, storage system, Wi-Fi port, power supply, and peripheral ports housed in a lightweight case.

However, laptop computer are not typically comprised of Raspberry Pi technology for printing and scanning; AC\DC power, QI charging, USB charging, lightning cable charging and Solar power methods; with Ethernet, LAN, Wi-Fi, Live 5, SATCOM, and Serial port connectivity methods.

Therefore, there is room for improvement within the art.

The present invention improvement is a single laptop computer, which combines several separate components/devices necessary to perform most office requirements for convenience, and practical access to several added services. The added components comprises a Touchscreen with full support for stylus, Printer, Scanner, Qi charger support, Solar Power Panels/Support, lightning cable ports, USB 2, 3, C ports, Satellite communication ports, Raspberry Pi(s). The laptop dimensions are not dramatically changed due to the added components. The printer can print standard 8″×11″ paper. The invention consist of multiple versions of one sleek low profile laptop unit design by which all of the aforementioned devices and features are combined into the one laptop. The Educational, Gaming, Developer, and Government purposed versions feature the same core components (like all models) are cross platform compatible with wireless and conventional software operating systems (OSes) and technologies. The present invention improvements solves the #1 problem of purchasing many separate devices to connect to a laptop and #2 enables true disaster recovery standalone computing functionality when desired or necessary. With the All-In-One Laptop all that is needed is to press the power/on button and you are up in running. With the solar panels and SATCOM satellite features there is no need to plug into an AC power outlet or to connect into an ISP wireless network. The aforementioned features make the present invention a huge improvement over other laptops of the past years in the art.

### SUMMARY OF INVENTION

The present invention is designed to make it more convenient for laptop users to make business, work, computer gaming, computer research, communications, and related task pertaining to its use faster and easier. The functionality of this all-in-one laptop is achieved by combining conventional and non-standard technologies, which are normally purchased separately, into one laptop. This added functionality in the All-In-One Laptop; make the laptop unique and far more advanced than other laptops in the art.

The present invention technology and features are comprised of: 1) Touch Screen with full haptic touch support. 2) Printer and Scanner with paper tray integrated onboard the laptop. 3) External Solar Power panel(s) to provide power to laptop and compatible external devices, and an alternative source for the wireless power source for the laptop 4) Qi charging to provide wireless charging of laptop and external compatible devices such as cellphones 5) 27 pin serial port to provide SATCOM/HAM/sim signal extender capability (6) lightning cable port to provide bi-directional charging of Apple devices (7) micro USB port to provide bi-directional charging of non-Apple devices (8) Raspberry Pi(s) for management of printer and scanner, and networking (9) Hot swappable CPU(s) to provide for flexible CPU(s) management (10) Hot swappable GPU(s) to provide for flexible GPU(s), including cross platform management (11) multi HDD/SSD hard drive bays, minimally 2 HDD/SSD.

The present invention consolidates the aforementioned features into one super laptop improvement by combining the aforementioned features into one laptop without drastically changing the overall dimensions or weight of current laptops in the art. This is also our main claim for our All-In-One Laptop Improvement.

### BRIEF DESCRIPTION OF THE DRAWING

The components in the drawings are not necessarily drawn to scale, the emphasis instead placed upon clearly illustrating the principles of the present disclosure. Moreover, in the drawings are like reference numerals to designate corresponding parts throughout the views.

FIG. 1 is an Isomeric view of the present invention with the touchscreen and stylus denoted.

FIG. 2 is an exploded view of the present invention displaying the printer/scanner component.

FIG. 3 is an exploded view displaying of key components of the present invention.

FIG. 4 is an Isomeric view of the present invention with the power ports, connectivity ports.

### NUMERIC REFERENCE FOR DRAWINGS

100—Isometric View of All-In-One-Laptop
101—LCD Assembly with Touch Screen (isometric view)
102—Stylus
103-104 keyboard

200—Isometric View of All-In-One-Laptop with exploded View of Printer/Scanner
203—Printer/Scanner enclosure
205—Printer/Scanner paper Tray
207—Printer/Scanner slot

300—Exploded View of All-In-One Laptop
301—LCD Assembly Touch Screen
303-104 Keyboard
305—Motherboard
307—Printer/Scanner with paper tray
309—Lower housing Assembly of All-In-One Laptop
400—Isomeric View of All-In-One Laptop with Connectivity and Power ports
401—LCD Assembly Touch Screen
402—Solar Power Panel
403—Power Ports
404—Connectivity Ports
405—Illustration of A4 paper discharging from printer/scanner
406—Qi Charger
410—Printer/Scanner discharge slot

### DETAIL DESCRIPTION OF PREFERRED EMBODIMENTS

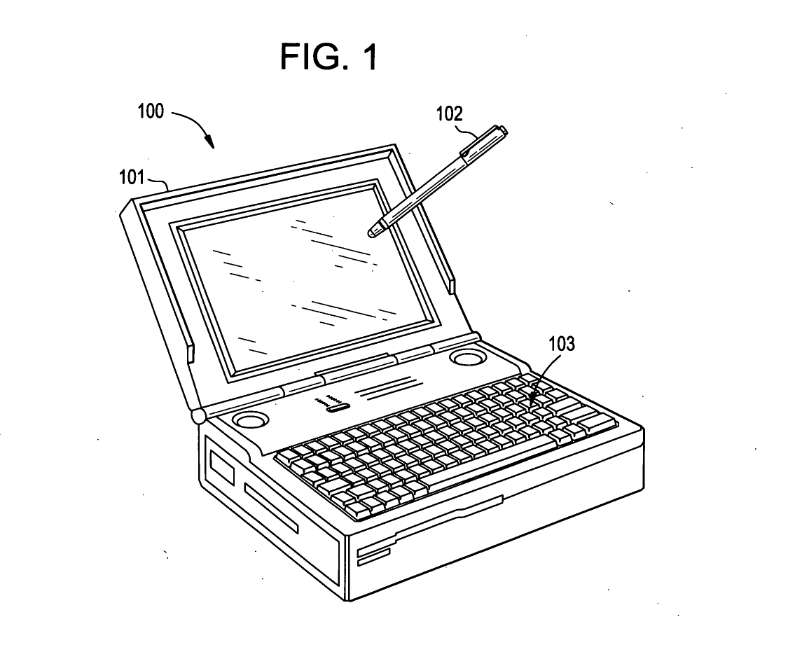

Referring to FIG. 1, an embodiment of an all-in-one laptop 100, includes a touchscreen (101) with full support for stylus (102). The touchscreen is connected to fully haptic touch capable LCD panel (often just called the touch screen).

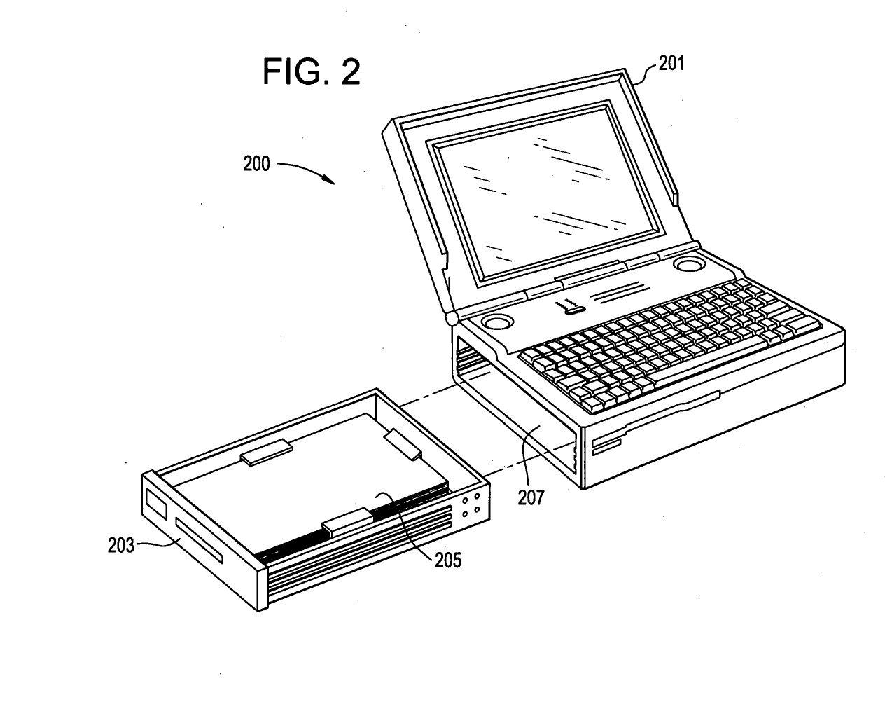

Referring to FIG. 2, an embodiment of the all-in-one-laptop (100) comprises a printer and scanner (203) within a slot or bay (207) that is managed by Raspberry Pi Servo technology. One of ordinary skill in the art will recognize that the configurations listed above are merely examples. Any number of other configurations may also be used in embodiments.

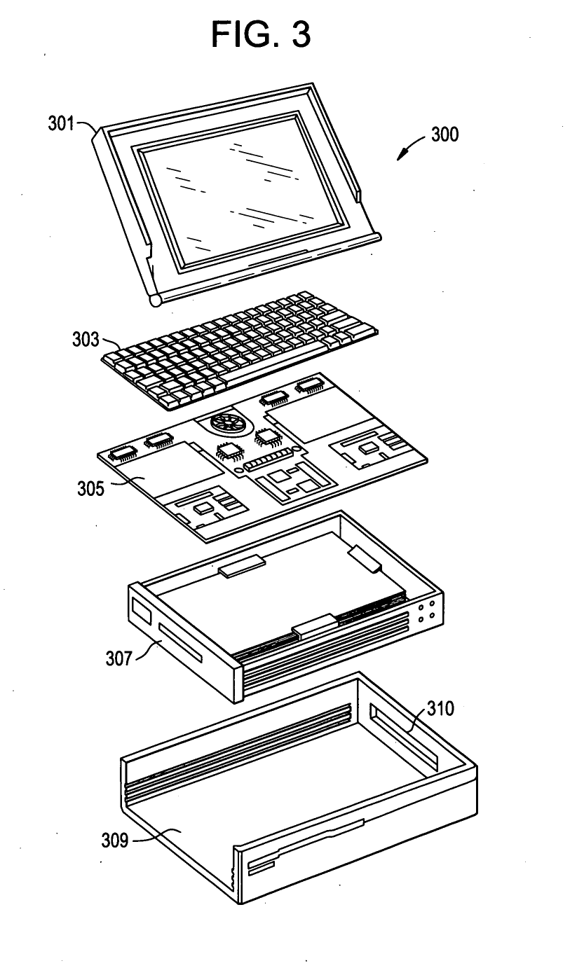

Referring to FIG. 3, an embodiment of the all-in-one laptop (100) comprises a LCD Assembly (301) which includes networking wires attached to internal touchscreen capable screen. One of ordinary skill in the art will recognize that the configurations listed above are merely examples. Any number of other configurations may also be used in embodiments.

Referring to FIG. 3, an embodiment of an all-in-one laptop (100) comprises a standard 104 keyboard (303) attached to motherboard. One of ordinary skill in the art will recognize that the configurations listed above are merely examples. Any number of other configurations may also be used in embodiments.

Referring to FIG. 3, an embodiment of an all-in-one laptop (100) comprises a motherboard (305) configured to be interoperable with hot swappable CPUs and GPUs; Raspberry Pis for managing printer, scanner and networking services. One of ordinary skill in the art will recognize that the configurations listed above are merely examples. Any number of other configurations may also be used in embodiments.

Referring to FIG. 3, an embodiment of the all-in-one laptop (100) comprises a printer/scanner component (307) with print/scanner paper tray (internal), and cartridges and light-bulb slots. One of ordinary skill in the art will recognize that the configurations listed above are merely examples. Any number of other configurations may also be used in embodiments.

Referring to FIG. 3, an embodiment of the all-in-one laptop (100) comprises an all-in-one laptop 100 lower housing (309) with printer paper discharge slot (310). One of ordinary skill in the art will recognize that the configurations listed above are merely examples. Any number of other configurations may also be used in embodiments.

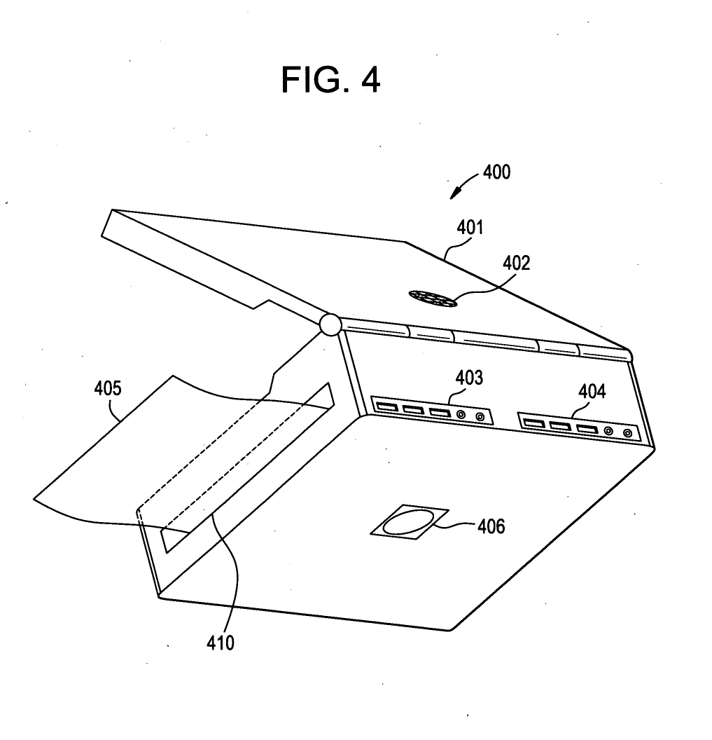

Referring to FIG. 4, an embodiment of the all-in-one laptop (100) comprises the before mentioned solar power panel (402), which can be on the outer shell of the touchscreen or include additional panels that can/would unfold and extend beyond the basic dimensions of the base. This configuration is configurable on all models/configurations of such a laptop. One of ordinary skill in the art will recognize that the configurations listed above are merely examples. Any number of other configurations may also be used in embodiments.

Referring to FIG. 4, an embodiment of the all-in-one laptop (100) comprises the before mentioned 5 unique power connection ports (403). One of ordinary skill in the art will recognize that the configurations listed above are merely examples. Any number of other configurations may also be used in embodiments.

Referring to FIG. 4, an embodiment of the all-in-one laptop (100) comprises the before mentioned 5 unique connectivity port (404). One of ordinary skill in the art will recognize that the configurations listed above are merely examples. Any number of other configurations may also be used in embodiments.

Referring to FIG. 4, an embodiment of the all-in-one laptop (100) comprises the before mentioned a4 paper illustration (405). One of ordinary skill in the art will recognize that the configurations listed above are merely examples. Any number of other configurations may also be used in embodiments.

Referring to FIG. 4, an embodiment of the all-in-one laptop (100) comprises the before mentioned Qi charger (406). One of ordinary skill in the art will recognize that the configurations listed above are merely examples. Any number of other configurations may also be used in embodiments.

Referring to FIG. 4, an embodiment of the all-in-one laptop (100) comprises the before mentioned paper discharge slot (410). One of ordinary skill in the art will recognize that the configurations listed above are merely examples. Any number of other configurations may also be used in embodiments.

What is claimed is:

1. A multi-functional All-In-One Laptop comprising multiple components integrated into one physical laptop.

2. The multi-functional All-In-One Laptop of claim 1, wherein said multiple components comprise: (1) touchscreen and stylus for signing contracts, (2) printer and scanner with paper tray for scanning and printing business documents, (3) solar power panel(s) to provide power to laptop when AC/DC power is not available, (4) Qi charger for wirelessly powering laptop and/or compatible external devices such as iPhone, (5) 27 pin serial Satellite port for standalone SATCOM connectivity, (6) lightning cable port for bidirectional charging of Apple compatible devices, (7) micro usb port for bidirectional charging of non-Apple compatible devices, (8) Raspberry Pi(s) serving the role of servo for management of printer and scanner as well as networking functionality (9) Hot swappable CPU(s) for core processing functionality, (10) Hot swappable GPU(s) for providing Graphic functionality (11) and multi HDD/SSD hard drive bays to provide at minimum a dual I-IDD/SSD functionality (including 2 disk raid O/1)

3. The multi-functional All-In-One Laptop of claim 2, further comprising a combination of 5 power methods and 5 connectivity methods.

4. The multi-functional All-In-One Laptop of claim 3, wherein said power methods comprise AC\DC power, QI charging, USB charging, lightning cable charging and Solar power.

5. The multi-functional All-In-One Laptop of claim 4, wherein said connectivity methods comprise Ethernet, LAN, Wi-Fi, Live 5, SATCOM, and Serial connectivity ports.
